(19) United States
(12) Patent Application Publication
(10) Pub. No.: US 2007/0208647 A1
(43) Pub. Date: Sep. 6, 2007

(54) System and method for placing a trade order for a tradeable instrument on an electronic exchange

(75) Inventors: Steffen Gemuenden, Chicago, IL (US); Igor Sluga, Frankfurt am Main (DE)

Correspondence Address: COOK, ALEX, MCFARRON, MANZO, CUMMINGS & MEHLER LTD, SUITE 2850, 200 WEST ADAMS STREET, CHICAGO, IL, 60606, US

(73) Assignee: RTS Realtime Systems GMBh

(21) Appl. No.: 11/365,370

(22) Filed: Mar. 1, 2006

(51) Int. Cl. G06Q 40/00

(52) U.S. Cl. 705/37

(57) ABSTRACT

A system and method for placing a trade order for a tradable instrument on an electronic exchange. The method includes displaying a trade order dartboard on a client terminal where the dartboard displays a market depth of the tradable instrument comprising information representing trade orders at an inside market and outside of the inside market through a dynamic display of prices, bid and ask quantities for the tradable instrument. The method also includes displaying a selected-price display displaying a first price therein in response to detecting a first user action via the user input device, initiating placement of a trade order relating to the tradable instrument at the first price in response to detecting a second user action via the user input device, and setting a trade order price of the trade order based in part upon one of a plurality of preset parameters and the first price.

### CROSS-REFERENCE TO RELATED APPLICATIONS

None

### BACKGROUND OF THE INVENTION

The present invention generally relates to electronic trading, and more specifically, to a system and method for placing a trade order for a tradable instrument on an electronic exchange.

Throughout the world, computerized electronic trading of tradable instruments such as stocks/equities, bonds, futures, options, currencies, warrants, commodities, etc., is replacing traditional face-to-face open-outcry trading. In general, such electronic trading is facilitated using computer network schemes that may include computers hosted by one or more trading exchanges (e.g., CME, CBOT, EUREX,), communication servers and/or networks, and end-user computers or electronic terminals. For ease of discussion, the computers and networks hosted by one or more trading exchanges are herein referred to as the “host system”, and the end-user computers or electronic terminals are herein referred to as “client terminals”.

Operations provided by the host system include maintaining order books, order-matching, price discovery and market data distribution for the online trading day as well as nightly batch runs. The host system is also equipped with external interfaces that maintain uninterrupted online contact to quote vendors and other price information systems.

The host system is communicatively coupled to any number of client terminals via corresponding exchange gateways and/or provider server equipment including trading software, which provides an interface between the host system and the client terminal(s). The users of the client terminals, hereinafter referred to as “traders” may include investment banks, proprietary trading firms, individual traders, hedgefunds, brokers, market makers, on-line brokers, corporations, clearing companies and the like. Trader access to the host system may be enabled using one of any number communications networks between the client terminal and the host system, including wired and wireless communication networks. Once access is established, data is bi-directionally transmitted between a client terminal and the host system. This allows traders located at the client terminal to establish a connection to the host system via, for example, the Internet.

Traders typically use software that generates specialized interactive trading screens on the displays of their client terminals. Such software is typically provided by trading hardware/software providers (“providers”) such as trading exchanges, independent software vendors (ISVs), on-line brokers, investment banks, clearing companies, etc. The interactive trading screens enable the trader to obtain market data, enter trade orders, cause trade orders to be executed, and monitor positions (i.e., executed trade orders). The range and quality of features available to traders on their trading screens vary according to the specific software application being run. The installation of open interfaces in the development of an exchange's electronic strategy means traders can choose, depending on their trading style and internal requirements, the trading software by which they will access the host system.

As is known, the trading exchanges provide volatile tradable instruments having prices that move rapidly up and down. To profit in these markets, traders must be able to react quickly. A skilled trader with the quickest trading software, the fastest communications, and the most sophisticated analytics can significantly improve his/her own bottom line. The slightest speed advantage can generate significant returns in the rapidly moving market, and a trader lacking technologically advanced trading software, including a first-rate trading screen, is at a severe competitive disadvantage.

As is also known, each market supplies and requires the same information to and from every trader. The bids (buys) and asks (sells) for each tradable instrument in the market form the market data and every logged-on trader can receive this market data if the trading exchange provides it. Similarly, every trading exchange requires that certain information be included with each trade order. For example, traders must supply information such as the name of the tradable instrument, quantity, order restrictions, price and multiple other variables. Without all of the required information, the trading exchange will not accept the trade order for execution.

With the aforementioned variables being constant, a competitive speed advantage must come from other aspects of the trading cycle. The steps required to place a trade order for a tradable instrument contribute in different amounts to the total time it takes to place the trade order. For example, the time required for market data to be transmitted from the host system to the client terminal is approximately 10-45 milliseconds, and the time required for a trade order to be transmitted from the client terminal to the host system and for the host system to confirm receipt of the trade order is approximately 10-90 milliseconds. Additionally, the time it takes for the trader to recognize the received market data and to place the trade order is approximately 500-2000 milliseconds. Accordingly, the total time for market data transmittal from the host system, assimilation of the market data by the trader, placement of the trade order based on the received market data and trade order confirmation ranges between approximately one-half of a second to slightly more than two seconds, in a best case scenario.

The market is constantly updating as many traders are placing trade orders, changing trade order and canceling trade orders simultaneously. It fact, successful markets strive to have such a high volume of trading that any trader who wishes to enter a trade order will find a match and have the order filled quickly, if not substantially immediately. In such liquid markets, the prices of the tradable instruments fluctuate rapidly. On a trading screen, this results in rapid changes in the price and quantity fields within a market grid. If a trader intends to enter a trade order at a particular price, but misses the price because the market prices moved before he could enter the trade order, he may lose hundreds, thousands, even millions of dollars. The faster a trader can trade, the less likely it will be that he will miss his price and the more likely he will make money.

A click-based trading method and system for reducing the time it takes to place a trade order for a commodity is disclosed in U.S. Pat. No. 6,938,011, to Kemp II et al. ('011 patent) and assigned to Trading Technologies International. The '011 patent utilizes a trading screen having columns of cells where one column includes the market depth of a commodity being traded. The trading screen enables a trader to place trade orders within the market depth with a single mouse click, presumably reducing the time it takes to place a trade order for a commodity.

Use of the trading screen of the '011 patent requires however, that for every new trade order price selected, the trader must move the mouse to align the mouse pointer to a particular buy/bid cell or ask/sell cell displayed on the trading screen, and then select (via the mouse click) the buy or sell trade order at the desired limit price indicated by mouse pointer location. Such alignment requires that the mouse be physically moved either up or down and in most cases, to the left or right side of the trading screen. Accordingly, the precise alignment of the mouse pointer to a particular trading screen cell uses precious seconds; seconds that may determine a good trade verses a bad trade in a rapidly fluctuating market.

### SUMMARY OF THE INVENTION

In general, a system and method are provided for placing a trade order for a tradable instrument on an electronic market. More specifically, the system and method disclosed and claimed herein utilizes a selected-price display on a trade order dartboard of a trading screen. The selected-price display is configured to display and highlight, for easy viewing, each price selected by a trader for each trade order. The selected-price display may be one of any dynamically updated price display means including a dynamic display window, a dynamic highlighted row or cell of a trade order dartboard, or a dynamically updated button display, to name a few. Each price is “loaded” into the selected-price display via one of a number of ways using the user input device (e.g., computer mouse). As a result, it is not always necessary to physically move the mouse each time a new price is desired for the trade order, and therefore more rapid placement of the trade order is possible.

In accordance with an aspect of the invention, a system and method is provided for placing a trade order for a tradable instrument on an electronic exchange using a client terminal including a user input device and a display device. The method includes displaying a trade order dartboard where the trade order dartboard displays a market depth of the tradable instrument having information representing orders at an inside market and orders outside of the inside market through a dynamic display of a plurality of prices and a plurality of bid quantities and ask quantities in the market for the tradable instrument. The method also includes displaying a selected-price display on the trade order dartboard, displaying a first price of the plurality of prices in the selected-price display in response to detecting a first user action via the user input device. The method further includes initiating placement of a trade order relating to the tradable instrument at the first price in response to detecting a second user action via the user input device. The method additionally includes setting a trade order price of the trade order based in part upon one of a plurality of preset parameters and the first price.

In accordance with another aspect of the invention, a system and method is provided for placing a stop order for a tradable instrument on an electronic exchange using a client terminal including a user input device and a display device. The method includes displaying a trade order dartboard where the trade order dartboard displays a market depth of the tradable instrument having information representing orders at an inside market and orders outside of the inside market through a dynamic display of a plurality of prices and a plurality of bid quantities and ask quantities in the market for the tradable instrument. The method also includes detecting selection of a first button image (Stop order button) of the trade order dartboard, displaying a selected-price display on the trade order dartboard, and displaying a first price of the plurality of prices in the selected-price display in response to a first user action via the user input device. The first price determines a stop price. The method further includes initiating placement of a stop order relating to the tradable instrument upon detecting a second user action via the user input device. The stop order is activated when a last executed trade order price overlaps the stop price. A stop order price of the stop order is based in part upon one of a plurality of preset parameters and on a second price equal to a market price of the tradable instrument at the time of trade order activation. Alternatively, the stop order price is based in part upon one of a plurality of preset parameters and a second price equal to the first price plus a predetermined offset amount.

In accordance with a further aspect of the invention, a computer readable medium has program code recorded thereon for execution on a computer to place a trade order for a tradable instrument on an electronic exchange. The computer readable medium includes a first program code recorder thereon for displaying a trade order dartboard. The trade order dartboard displays a market depth of the tradable instrument having information representing orders at an inside market and orders outside of the inside market through a dynamic display of a plurality of prices and a plurality of bid quantities and ask quantities in the market for the tradable instrument. The computer readable medium has a second program code recorded thereon for displaying a selected-price display on the trade order dartboard, a third program code for displaying a first price of the plurality of prices in the selected-price display in response to detecting a first user action via a user input device, a fourth program code for initiating placement of a trade order relating to the tradable instrument at the first price in response to detecting a second user action via the user input device, and a fifth program code for setting a trade order price of the trade order based in part upon one of a plurality of preset parameters and the first price.

In accordance with another aspect of the invention, a client system places a trade order for a tradable instrument on an electronic exchange. The client system includes a display device configured to display a trade order dartboard including a selected-price display on the trade order dartboard. The trade order dartboard displays a market depth of the tradable instrument comprising information representing orders at an inside market and orders outside of the inside market through a dynamic display of a plurality of prices and a plurality of bid quantities and ask quantities in the market for the tradable instrument. The client system also includes a user input device configured to enable a first user action causing a first price of the plurality of prices to be displayed in the selected-price display, and configured to enable a second user action to initiating placement of a trade order relating to the tradable instrument at the first price. The client system additionally includes a trade order characteristic setting component configured to set a trade order price of the trade order based in part upon one of a plurality of preset parameters and the first price

It should be understood that the present invention includes a number of different aspects and/or features which may have utility alone and/or in combination with other aspects or features. Accordingly, this summary is not an exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a diagram of an exemplary electronic trading network including a trading exchange host system and a trading firm system having client terminals.

FIG. 2 is a more detailed diagram of the trading firm system of FIG. 1, according to an embodiment of the invention.

FIG. 3 is an exemplary trading screen that may be utilized by a trader located at a client terminal of the trading firm system of FIG. 2, according to an embodiment of the invention.

FIG. 4 is a method for placing a buy or sell trade order for a tradable instrument on an electronic exchange using the client terminal of the trading firm system of FIG. 2, according to an embodiment of the invention.

FIG. 5 is a method for placing a buy or sell stop order at a market price for a tradable instrument on an electronic exchange using the client terminal of the trading firm system of FIG. 2, according to an embodiment of the invention.

FIG. 6 is a method for placing a buy or sell stop order at a limit price for a tradable instrument on an electronic exchange using the client terminal of the trading firm system of FIG. 2, according to an embodiment of the invention.

### DETAILED DESCRIPTION OF THE PREFERRED EMBODIMENTS

As described with reference to the accompanying figures, the present invention provides a system and method for placing a trade order for a tradable instrument on an electronic market. The system and method include utilizing a trade order dartboard having a current market display of a tradable instrument's market depth, and a selected-price display. A tradable instrument's market depth is a selected number of current bid and ask prices (e.g., 10 bid prices and 10 ask prices) and quantities for that particular tradable instrument at that particular instant in time. Unlike prior art methods, the system and method for placing a trade order described herein includes use of the selected-price display to preclude the need to physically move the mouse either up or down and/or to the left or right side of the trading screen each time a trade order is placed. The selected-price display may be one of any dynamically updated price display means including a dynamic display window, a dynamic highlighted row or cell of a trade order dartboard, or a dynamically updated button display, to name a few. Accordingly, use of the selected-price display facilitates rapid placement of trade orders within the market depth.

The present invention is preferably implemented on a personal computer or electronic terminal. It is contemplated that the present invention may also be implemented on any type of microprocessor-based or computing device having a display capability and being communicatively coupled, either directly or indirectly, to one or more trading exchanges.

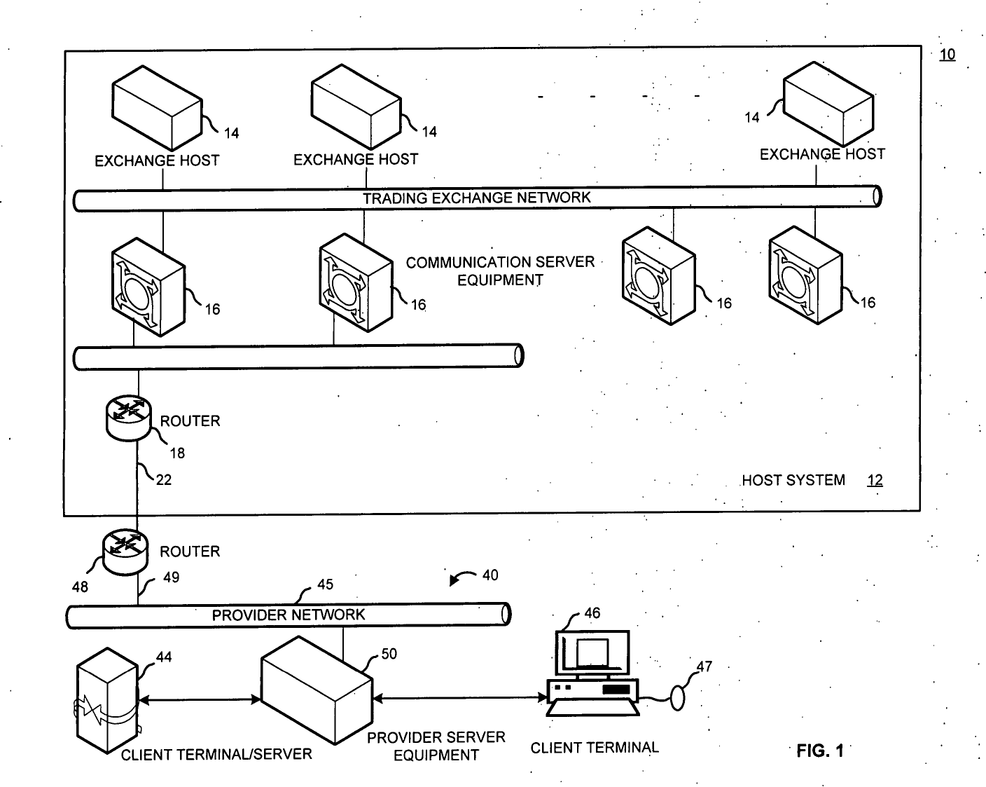

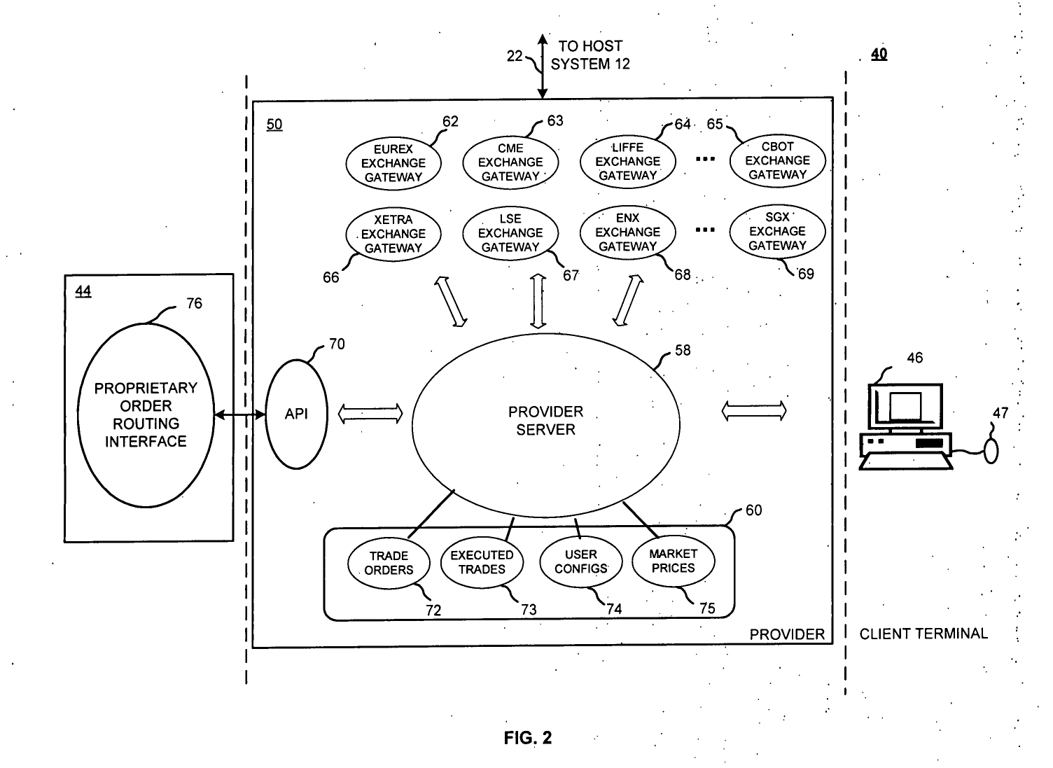

FIG. 1 is a diagram of an exemplary electronic trading network 10 including a trading exchange host system 12 and a trading firm system 40 having a number of client terminals 44, 46. In the illustrated example, the client terminal 44 is shown as a server that includes a proprietary interface (see, FIG. 2). The host system 12 is operatively coupled to the trading firm system 40 via at least one host network router 18 and at least one trading firm network router 48 and a communications link 22 there between. The communications link 22 may be one of any number of suitable communications links such as, for example, a LAN, a WAN, the Internet, etc., to allow communication between the client terminals 44, 46 and the trading exchange hosts 14. Although only one trading exchange host system 12 and one trading firm system 40 are illustrated in FIG. 1, it should be understood that additional trading exchange host systems 12 and/or additional trading firm systems 40 may be included in the electronic trading network 10.

Referring to FIG. 1, the host system 12 includes a number of trading exchange hosts 14 configured to enable execution of trade orders placed by traders via the client terminals 44, 46, to maintain order books, positions, price information, to manage and update trading exchange(s) databases and to provide trading exchange host system data such as market data, market prices and executed trade orders to the client terminals 44, 46. The host system 12 also includes communication server equipment 16 configured to distribute trading exchange host system data to trading firm system 40 and forward incoming trade orders to the trading exchange host(s) 14, and the host network router(s) 18 configured to route incoming and outgoing data to and from the host system 12.

Although configured with three trading exchange hosts 14, four communication servers 16, and one router 18, it is contemplated that the host system 12 may be one of any number of suitable configurations to enable electronic trading.

The trading firm system 40 includes provider server equipment 50 operatively coupled to the host system 12 via a provider network 45 and the trading firm router(s) 48. As illustrated, the first and second client terminals 44, 46 are operatively coupled to the provider server equipment 50 using well known means (e.g., a LAN, a WAN, wireless networks, Internet). Although only two client terminals are illustrated, it should be understood that many client terminals may be included in the trading firm system 40.

Each of the first and second client terminals 44, 46 is configured to enable electronic trading by one or more traders. For example, the first client terminal 44 may be associated with an on-line broker (e.g., Charles Schwab, ETrade, TD Waterhouse) and therefore be communicatively coupled to a number of personal computers (via, for example, the Internet) to allow traders to place trade orders from the comfort of their home or office. The second client terminal 46 may be associated with a trading firm and may therefore be located in a trading firm's office, a third party location or a trading exchange building to enable the trader to place trade orders.

In the illustrated example, the second client terminal 46 includes a user input device 47. Although preferably a computer mouse having right button to enable a right click, a left button to enable a left click and a center scroll wheel to enable one dimensional scrolling, the user input device 47 may be one of any number of suitable input devices capable of manipulation by a trader for the purpose of placing trade orders (e.g., a keyboard/key pad, a biometric input device).

The provider server equipment 50 and its associated software may be provided by one of any number of entities. For example, the provider server equipment 50 and associated software may be provided by a trading exchange, an Independent Software Vendor, an on-line broker, investment bank, a clearing house or any corporation involved in electronic trading, to name a few. In general, the provider server equipment 50 includes a provider server(s), a database(s), one or more application program interfaces (API) and one or more exchange gateways.

More specifically, FIG. 2 is a more detailed diagram of the trading firm system 40. The trading firm system 40 is configured to enable a trader via a client terminal to place a trade order for a tradable instrument on an electronic market of the electronic trading network 10, according to an embodiment of the invention. As illustrated, the provider server equipment 50 includes a provider server 58, a provider database 60 and a number of exchange gateways 62-69. The provider server 58 is configured to route trading exchange host system data to the client terminals 44, 46 and to route trade orders to the host system 12. The provider server 58 also provides market data and executed trade orders to the client terminals 44,46

A database(s) 60 is included in the provider server equipment 50, and is configured to maintain data associated with trade orders 72, executed trade orders 73, user configurations 74 and market prices 75, to name a few. An API(s) 70 is included to enable data flow between a proprietary order routing interface 76 of the first client terminal 44 and the provider server 58. Each of the exchange gateways 62-69 may include provider software and/or trading exchange software to enable the provider server 58 to communicate with the individual trading exchanges. The exchange gateways 62-69 are configured to translate the different exchange data structures and message types into data structures and message types suitable for use by the provider server 58, and vice versa.

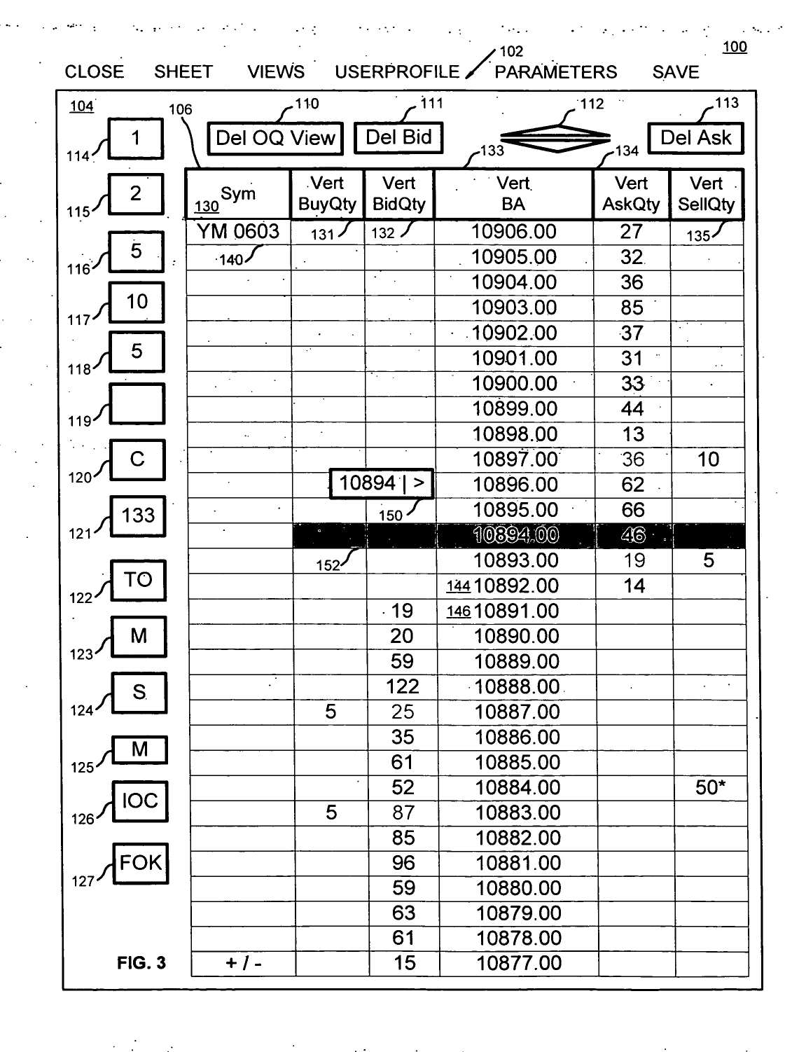

As discussed above, a trader located at a client terminal utilizes a trading screen to enable placement of trade orders. For example, FIG. 3 is an exemplary trading screen 100 that may be utilized by a trader located at the client terminal 46 to place a trade order for a tradable instrument on an electronic market of the trading exchange host system 12, according to an embodiment of the invention. The trading screen 100 may be displayed on any suitably configured display of the client terminal 46.

Referring to FIG. 3, the trading screen 100 includes a menu bar 102 having a number of menu selection buttons (e.g., Views, User Profile) and associated pull-down menus, and a trade order dartboard 104 (“dartboard 104”). A selected-price display 150 is also included to enable enhanced trader viewing of prices he or she selects for placement of trade orders. For ease of discussion, the selected-price display 150 is configured as a dynamic display window. It should be understood however, the selected-price display may also be configured as a dynamic highlighted row 152 where the highlighted row 152 scrolls in tandem with trader actions via the user input device (e.g., mouse pointer movement, center scroll wheel movement). The selected-price display may also be a dynamic cell of the trade order dartboard 104, or a dynamically updated button display on or proximate to the trade order dartboard, to name a few

As described in detail below, loading the selected-price display 150 with the trader selected price can be achieved via placement of the mouse pointer over a particular price displayed on the trade order dartboard 104 and/or scroll wheel movement with the mouse pointer in the dartboard 104. In the illustrated example of FIG. 3, the dartboard 104 is a vertical dartboard however other physical orientations are possible.

The dartboard 104 includes a spread sheet 106 and a number of buttons and button displays 110-127. The spread sheet 106 includes columns 130-135, with each column having a plurality of cells. The first or Sym column 130 is configured to display a tradable instrument 140; in this example, the character string YM 0603 displayed in a top cell of the column 130. The second or Vert BuyQty column 131 is configured to display one or more trader selected buy trade order quantities associated with a price of the tradable instrument 140, the third or Vert BidQty column 132 is configured to display the available quantity of tradable instruments 140 available for purchase at an associated price. The fourth or Vert BA column 133 displays a price ladder of the prices at a market depth of the tradable instrument representing prices at an inside market and prices outside (i.e., above and below) of the inside market.

In the illustrated example, a price of 10892.00 displayed in cell 144 is the best or lowest price for a sell trade order (i.e., an ask price) and a price of 10891.00 displayed in cell 146 is the best or highest price (i.e., a bid price) for a buy trade order. The ask and bid prices displayed in cells 144 and 146 therefore represent the “inside market”. Those prices displayed above the cell 144 include a list of the next-best ask prices and below the cell 146 include a list of the next-best bid prices and therefore represent the “outside of the inside market”.

The fifth or Vert AskQty column 134 is configured to display the available quantity of tradable instruments 140 available for sale at an associated price, and the sixth or Vert SellQty column 135 is configured to display one or more trader selected ask trade order quantities associated with a price of the tradable instrument. While appearing static, it should be understood that the dartboard 104 of FIG. 3 is a snapshot of a dynamic dartboard with the price ladder of column 133 moving upward and downward as the inside market changes.

Referring to the buttons and button displays 110-127, when the Del OQ View button 110 is selected by the trader, current trade orders displayed in the spreadsheet 106 are caused to be deleted. Similarly, when the Del Bid button 111 is selected by the trader, trade order buy quantities displayed in the Vert BuyQty column 131 are caused to be deleted and associated cells updated, and when the Del Ask button 113 is selected by the trader, trade order sell quantities displayed in the Vert SellQty column 135 are caused to be deleted and associated cells updated. When the arrow button 112 is selected by the trader, the spread sheet 106 is shifted downward or upward depending on which portion of the arrow button 112 is selected.

Rather than requiring manual entry of buy quantities and sell quantities for each trade order, the dartboard 104 is configured to allow the trader to pre-define default settings such as the trade order quantity. For example, the default quantity button display 118 displays a pre-defined default setting of the trade order quantity; in the illustrated example, a 5 trade order quantity. Thus, when the default trade order quantity is used, each trade order is expressed in quantities of 5 or multiples of 5 (e.g. 10, 20, 25), depending on the number of mouse clicks. The default trade order quantity may be changed via positioning the mouse pointer over the default quantity button display 118 and either right clicking to add to the default trade order quantity or left click to subtract from the default trade order quantity.

In some cases, it may be desirable to define a new trade order quantity for a particular trade order. Accordingly, trader selection of one or more of the quantity buttons 114, 115, 116, 117 defines the next trade order quantity appearing in the next order quantity display button 119. For example, if the quantity button 117 was selected one time and the quantity button 116 was selected one time, the next trade order quantity is reflected as 15 in the display button 119, and the trade order quantity will be 15 or multiples thereof. Additional functionality includes positioning the mouse pointer over one of the quantity buttons 114, 115, 116, 117, and then right clicking and holding to display a menu of other numbers such as 1, 2, 5, 10, 50 and an enter button for custom quantity selection. This provides quicker selection of larger or smaller trade order quantities.

A clear button 120 is also provided to enable the trader to clear the trade order quantity appearing in the next order quantity display button 119. A current positions display button 121 is configured to display a sum of all executed trade orders or positions associated with the tradable instrument 140, and a TO button 122 is configured to enable the trader to “trade out “of his/her position; that is to offset the sum of all of the executed trade orders associated with the tradable instrument 140. When selected by the trader, the market order button 123 causes the next trade order to be executed at the market price (preferably the inside market price). When the FOK order restriction button 127 is selected by the trader, the next single trade order is either immediately fully filled at the selected price, or not filled at all. When the IOC order restriction button 126 is selected by the trader, the next trade order is either immediately fully or partially filled at the selected price, or not filled at all.

When selected by the trader, the stop order button 124 enables execution of either a buy or a sell stop order at a limit price or at a market price, when a selected stop price is reached. For example, to place a buy stop order at a market price (“buy stop order at market”), after left clicking the stop order button 124 and then positioning the mouse over one of the second, third, fourth, fifth or sixth column 131, 132, 133, 134, 135 to display a price in the selected-price display 150, a left click selects a stop price for the buy stop order at market, where the stop price is equal to the price displayed in the selected-price display 150. The stop price may be changed within the selected-price display 150 via scroll wheel movement with the mouse pointer located in the spreadsheet 106 or by moving the mouse pointer to another cell of the spreadsheet 106. The buy stop order at market will remain passive until the stop price is equal to the last executed trade order price for the tradable instrument, as detected by the trading exchange host system 12. Upon becoming active when the stop price is equal to the last executed trade order price, presumably at the “inside market”, the buy stop order at market will be placed and subsequently executed at the current market price.

Similarly, to place a sell stop order at a market price (“sell stop order at market”), after left clicking the stop order button 124 and then positioning the mouse over one of the second, third, fourth, fifth or sixth column 131, 132, 133, 134, 135 to display a price in the selected-price display 150, a right click selects a stop price for the sell stop order at market, where the stop price is equal to the price displayed in the selected-price display 150. The stop price may be also loaded in to the selected-price display 150 via scroll wheel movement with the mouse pointer located in the spreadsheet 106 or by moving the mouse pointer to another cell of the spreadsheet 106. The sell stop order at market will remain passive until the stop price is equal to the last executed trade order price for the tradable instrument, as detected by the host system 12. Upon becoming active when the stop price is equal to the last executed trade order price, the sell stop order at market will be placed and subsequently executed at the current market price.

As noted above, when selected by the trader, in addition to placing buy or sell stop orders at the market price, the stop order button 124 enables placement of either a buy or sell stop order at a selected price. As is known, placing a buy or sell stop order at a selected price (“buy or sell stop order at limit”) requires two prices; a first price is selected as the stop price or trigger price at which the buy or sell stop order at limit becomes active, and second price is selected as the limit price at which the buy or sell stop order limit should be executed. For example, for a buy stop order at limit, the first price determines a stop price at which the buy stop order at limit is activated by the trading exchange host system 12, and a second price determines a limit price at which the buy stop order at limit should be executed. Similarly, for a sell stop order at limit, the first price determines a stop price at which the sell stop order at limit is activated by the trading exchange host system 12, and a second price determines a limit price at which the sell stop order at limit should be executed.

Unlike prior art methods where both first and second prices are selected from the price ladder of column 133 via two mouse clicks for either a buy stop order at limit or a sell stop order at limit, the system and method for placing a trade order for a tradable instrument disclosed herein requires only one mouse click. This is achieved via trader pre-selection of one of a number of ticks (i.e., a minimum price increment of the tradable instrument), either upward or downward, depending on whether the stop order at limit is a buy stop order at limit or a sell stop order at limit. Such trader pre-selection of one of the number of ticks may be configured as a default setting.

Referring again to the trade order dartboard 104, the stop order offset button display 125 is associated with the stop order button 124, and displays an “M” as a default setting to indicate that a stop order is one of the buy stop order at market or the sell stop order at market. Additionally, the stop order offset button display 125 may be modified to include a trader selected number of ticks to indicate an offset or difference between the first (stop) price and the second (limit) price. Prior to placing the trade order, the number of ticks may be pre-selected by the trader via entering the number directly into the stop order offset button display 125, or positioning the mouse pointer over the stop order offset button display 125, right clicking and holding to display a ticks menu and then selecting the number of ticks from the ticks menu.

In the case of a buy stop order at limit, after left clicking the stop order button 124 and then positioning the mouse over one of the second, third, fourth, fifth or sixth column 131, 132, 133, 134, 135 to display a price in the selected-price display 150, a left click selects a first price for the buy stop order at limit, where the stop price is equal to the first price displayed in the selected-price display 150. The stop price may also be loaded into or changed in the selected-price display 150 via scroll wheel movement with the mouse pointer located in the spreadsheet 106. The second price, or limit price at which the buy stop order at limit should be executed, is automatically determined by the number of preset ticks. Although preferably in a one-to-one correspondence with the cells of the spreadsheet 106, it is contemplated that each of the ticks may correspond to other quantities such as two cells of the spreadsheet 106.

For example, using a buy stop order at limit and referring to the selected-price display 150 of FIG. 3, if the stop price is selected as 10894 and the trader preset number of ticks is 3, the price at which the buy stop order at limit becomes active is 10894.00, and the price at which the buy stop order at limit is executed is 10897.00. Similarly, using a sell stop order at limit and referring to the selected-price display 150 of FIG. 3, if the stop price is selected as 10894 and the trader preset number of ticks is 3, the price at which the sell stop order at limit is activated is 10894.00, and the price at which the sell stop order at limit is executed is 10891.00

In some cases, it may be desirable to change a price of a trade order prior to its execution. This may be accomplished via positioning the mouse pointer over a trade order quantity displayed in the column 131 (Vert BuyQty) or in the column 135 (Vert Sell), and then right clicking and holding while repositioning the mouse pointer to a different cell of the column 131 or the column 135, respectively. The changed price of the trade order will appear in the selected-price display 150 and will remain in the selected-price display 150 upon releasing the holding.

The center scroll wheel may also be used to change the price of a trade order prior to its execution. This may be accomplished via positioning the mouse pointer over a trade order quantity displayed in the column 131 (Vert BuyQty) or in the column 135 (Vert Sell), and then right clicking and holding while scrolling the center scroll wheel. The changed price of the trade order will appear in the selected-price display 150 and will remain in the selected-price display 150 upon releasing the holding.

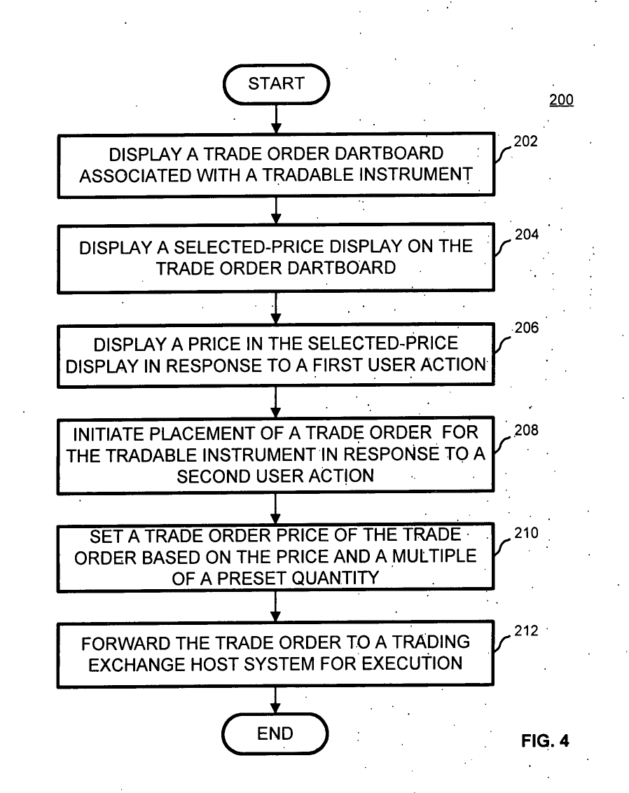

FIG. 4 is a method 200 for placing a buy or sell trade order for a tradable instrument 140 on an electronic exchange using the client terminal 46, according to an embodiment of the invention. The tradable instrument may be one of a stock/equity, a bond, a future, an option, a currency, a warrant, a commodity, or any other traded financial product.

Referring to FIG. 4, the method 200 includes displaying the trade order dartboard 104 (step 202). The trade order dartboard 104 included in the trading screen 100 may be displayed in response to an input by a trader via, for example, the user input device 47. The method also includes displaying the selected-price display 150 on the trade order dartboard 104 (step 204) in response to placement of a pointer of the user input device 47 over the trade order dartboard 150.

While preferably displayed on the trade order dartboard 104, the selected-price display 150 may be displayed in any suitable location on the trading screen 100 to enable easy viewing by the trader. For example, the selected-price display 150 may be displayed in the column 132 when the pointer of the user input device 47 is positioned over the column 134 or the column 135, or when the pointer of the user input device 47 is positioned over a portion of the column 133 associated with ask/sell quantities. Similarly, the selected-price display may be displayed in the column 134 when the pointer of the user input device 47 is positioned over the column 131 or the column 132, or when the pointer of the user input device 47 is positioned over a portion of the column 133 associated with bid/buy quantities.

Referring again to FIG. 4, the method 200 further includes displaying a first price of the plurality of prices displayed in the column 133 in response to detecting a first user action via the user input device (step 206). One of any number of first user actions may cause the first price to be displayed in the selected-price display 150. For example, the first price may be displayed in the selected-price display 150 when (A) the position of the pointer of the user input device 47 is detected over the trade order dartboard 104, (B) movement of the center scroll wheel is detected or (C) the position of a pointer of the user input device 47 is detected over the trade order dartboard 104 and movement of the center scroll wheel is detected.

The method 200 further includes initiating placement of a trade order relating to the tradable instrument 140 at the first price in response to detecting a second user action via the user input device 47 (step 208), and setting a trade order price of the trade order based in part upon one of a plurality of preset parameters (e.g., one or more multiples of a preset quantity) and the first price (step 210). One of a number of second user actions may initiate the trade order. For example, a sell trade order may be initiated when a right click with the pointer of the user input device 147 positioned over a price associated with the plurality of ask quantities of the column 134 is detected, or when a left click with the pointer of the user input device 47 positioned over an ask quantity associated with the plurality of ask quantities of the column 134 is detected. If the pointer of the user input device 147 is positioned over the column 134 however and the trader right clicks, a sell menu is displayed. If the pointer of the user input device 147 is positioned over the column 132 and the trader right clicks, a buy menu is displayed. A buy trade order may be initiated when a left click with the pointer of the user input device 47 positioned over a price associated with the plurality of bid quantities of the column 132 is detected, or when a left click with the pointer of the user input device 47 positioned over a bid quantity associated with the plurality of bid quantities of the column 132 is detected.

The plurality of preset parameters include trade order quantities, trading account information, trade order validity information, trade order restrictions and a predetermined amount or tick count (discussed below), to name a few. The trade order price is set based on the trade order quantity selected by the trader and the first price. As discussed in connection with FIG. 3, the trade order quantity may be preset such that multiple clicks yield multiples of preset quantities. The trade order is then automatically forwarded to the trading exchange host system 12 for execution (step 212).

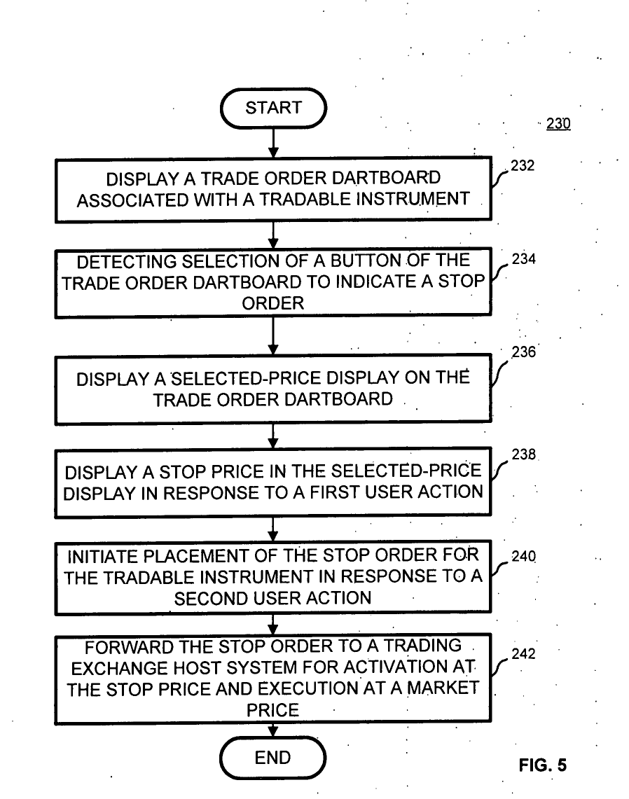

FIG. 5 is a method 230 for placing a buy or sell stop order at a market price for the tradable instrument 140 on an electronic exchange using the client terminal 46, according to an embodiment of the invention. The method 230 includes displaying the trade order dartboard 104 (step 232). The method 230 also includes detecting selection of the button 124 indicating the stop order (step 234), and displaying the selected-price display 150 on the trade order dartboard 104 in response to placement of a pointer of the user input device 47 over the trade order dartboard 150 (step 236). Selection of the button 124 preferably comprises detecting a left click with the pointer of the user input device positioned 47 over the button 124.

The method 230 further includes displaying a first price of the plurality of prices displayed in the column 133 in the selected-price display 150 in response to detecting a first user action via the user input device (step 238). The stop order has a stop price equal to the first price. The method 230 further includes initiating placement of the stop order in response to detecting a second user action via the user input device 47 (step 240).

The stop order is activated when a last executed trade order price is overlapping or equal to the stop price. A stop order price of the stop order is based in part upon one of a plurality of preset parameters and a second price, where the second price is equal to a market price of the tradable instrument at the time of stop order activation. The stop order is automatically forwarded to the trading exchange host system 12 for execution (step 242).

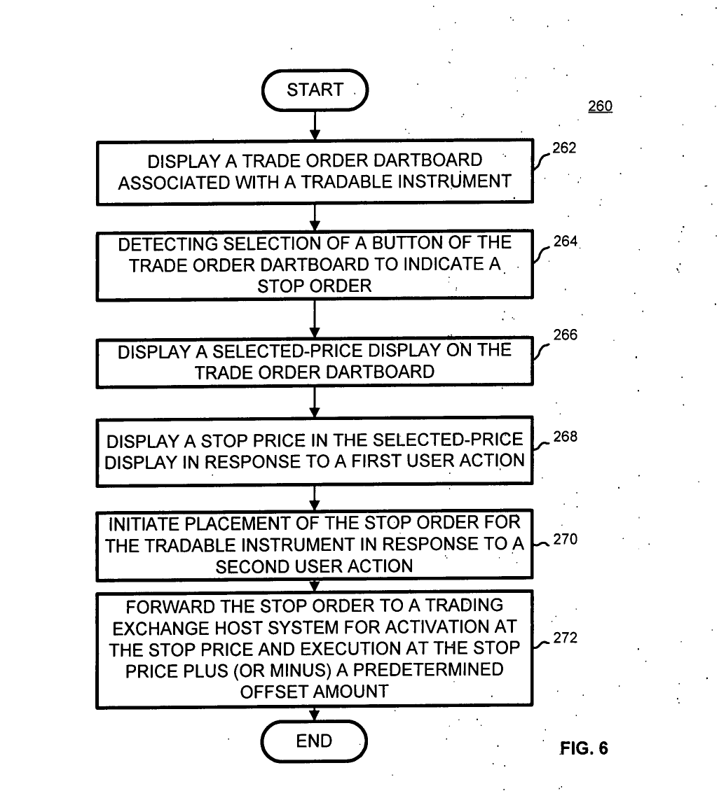

FIG. 6 is a method 260 for placing a buy or sell stop order at a limit price for a tradable instrument on an electronic exchange using the client terminal 46, according to an embodiment of the invention. The method 260 includes displaying the trade order dartboard 104 (step 262). The method 260 also includes detecting selection of the button 124 indicating the stop order (step 264), and displaying the selected-price display 150 on the trade order dartboard 104 in response to placement of a pointer of the user input device 47 over the trade order dartboard 150, and (step 266). Selection of the button 124 preferably comprises detecting a left click with the pointer of the user input device positioned 47 over the button 124.

The method 260 further includes displaying a first price of the plurality of prices included in the column 133 in the selected-price display 150 in response to detecting a first user action via the user input device (step 268). The stop order has a stop price equal to the first price. The method 260 further includes initiating placement of the stop order in response to detecting a second user action via the user input device 47 (step 270).

The stop order is activated when a last executed trade order price is overlapping or equal to the stop price. A stop order price of the stop order is based in part upon one of a plurality of preset parameters and a second price equal to the first price plus a predetermined offset amount. The predetermined offset amount decreases the first price to the second price when the stop order is a sell stop order, and increases the first price to the second price when the stop order is a buy stop order. In a preferred embodiment, the predetermined offset amount is a fixed number of ticks upward from the first price when the stop order is a buy stop order and a fixed number of ticks downward from the first price when the stop order is a sell stop order.

As is apparent from the above discussion, the system and method disclosed and claimed herein utilizes the selected-price display 150 on the trading screen 100 to preclude the need to physically move the mouse each time a new price selection is required for a trade order, and therefore enables more rapid placement of a trade order.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

The present invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

In one embodiment, the logical operations of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

What is claimed is:

1. A method for placing a trade order for a tradable instrument on an electronic exchange using a client terminal including a user input device and a display device, the method comprising:
displaying a trade order dartboard, the trade order dartboard displaying a market depth of the tradable instrument comprising information representing orders at an inside market and orders outside of the inside market through a dynamic display of a plurality of prices and a plurality of bid quantities and ask quantities in the market for the tradable instrument;
displaying a selected-price display on the trade order dartboard, the selected-price display displaying a first price of the plurality of prices in response to detecting a first user action via the user input device;
initiating placement of a trade order relating to the tradable instrument at the first price in response to detecting a second user action via the user input device; and
setting a trade order price of the trade order based in part upon one of a plurality of preset parameters and the first price.

2. The method of claim 1, wherein the trade order is an order to sell a quantity of the tradable instrument at the trade order price.

3. The method of claim 1, wherein the trade order is an order to buy a quantity of the tradable instrument at the trade order price.

4. The method of claim 1, wherein the user input device comprises a computer mouse having a right button to enable a right click, a left button to enable a left click and a center scroll wheel to enable scrolling.

5. The method of claim 4, wherein detecting the first user action comprises:
detecting a position of a pointer of the user input device over the trade order dartboard; and
detecting movement of the center scroll wheel, the movement causing the first price to be displayed in the selected-price display.

6. The method of claim 4, wherein detecting the first user action comprises detecting movement of the center scroll wheel, the movement causing the first price to be displayed in the selected-price display.

7. The method of claim 4, wherein detecting the first user action comprises detecting a position of a pointer of the user input device over the trade order dartboard.

8. The method of claim 4, wherein detecting the second user action comprises detecting a right click with the pointer of the user input device positioned over a price associated with the plurality of ask quantities.

9. The method of claim 4, wherein detecting the second user action comprises detecting a left click with the pointer of the user input device positioned over a price associated with the plurality of bid quantities.

10. The method of claim 4, wherein detecting the second user action comprises detecting a left click with the pointer of the user input device positioned over a bid quantity of the plurality of bid quantities.

11. The method of claim 4, wherein detecting the second user action comprises detecting a left click with the pointer of the user input device positioned over a ask quantity of the plurality of ask quantities.

12. The method of claim 4, wherein the first price is changed to another price of the plurality of prices in response to detecting movement of the center scroll wheel.

13. The method of claim 4, wherein, after setting the trade order price of the trade order, the first price is changed to another price of the plurality of prices in response to:
detecting a right click and a hold with the pointer of the user input device positioned over a trade order quantity of the trade order displayed on the trade order dartboard;
detecting repositioning of the pointer of the user input device to a location of the trade order dartboard associated with the another price, the another price displayed in the selected-price display; and
detecting release of the right click and the hold, a new trade order price based in part upon the one of the plurality of preset parameters and the another price.

14. The method of claim 4, wherein, after setting the trade order price of the trade order, the first price is changed to another price of the plurality of prices in response to:
detecting a right click and a hold with the pointer of the user input device positioned over a trade order quantity of the trade order displayed on the trade order dartboard;
detecting movement of the center scroll wheel, the movement causing the another price to be displayed in the selected-price display; and
detecting release of the right click and hold, a new trade order price based in part upon the one of the plurality of preset parameters and the another price.

15. The method of claim 1, wherein the user input device comprises a biometric input device, a keyboard, a radio frequency input device.

16. The method of claim 1, wherein the tradable instrument is selected from the group consisting of equities, options, futures, warrants, bonds, commodities and currencies.

17. The method of claim 1, further comprising adjusting a position of the selected-price display on the trade order dartboard.

18. The method of claim 1, wherein the position of the selected-price display is based on the first user action.

19. The method of claim 1, wherein the selected-price display is displayed in a bid quantity column of the trade order dartboard when the pointer of the user input device is positioned over an ask quantity of the plurality ask quantities.

20. The method of claim 1, wherein the selected-price display is displayed in a bid quantity column of the trade order dartboard when the pointer of the user input device is positioned over a limit price associated with the plurality ask quantities.

21. The method of claim 1, wherein the selected-price display is displayed in an ask quantity column of the trade order dartboard when the pointer of the user input device is positioned over a bid quantity of the plurality bid quantities.

22. The method of claim 1, wherein the selected-price display is displayed in an ask quantity column of the trade order dartboard when the pointer of the user input device is positioned over a limit price associated with the plurality bid quantities.

23. The method of claim 1, wherein the plurality of preset parameters is selected from the group consisting of trade order quantities, trading account information, trade order validity information and trade order restrictions.

24. A method for placing a stop order for a tradable instrument on an electronic exchange using a client terminal including a user input device and a display device, the method comprising:
displaying a trade order dartboard, the trade order dartboard displaying a market depth of the tradable instrument comprising information representing orders at an inside market and orders outside of the inside market through a dynamic display of a plurality of prices and a plurality of bid quantities and ask quantities in the market for the tradable instrument;
detecting selection of a first button image of the trade order dartboard, the first button indicating the stop order;
displaying a selected-price display on the trade order dartboard, the selected-price display displaying a first price of the plurality of prices in the selected-price display in response to a first user action via the user input device, the first price indicating a stop price; and
initiating placement of a stop order relating to the tradable instrument upon detecting a second user action via the user input device, the stop order activated when a last executed trade order price overlaps the stop price, a stop order price of the stop order based in part upon one of a plurality of preset parameters.

25. The method of claim 24, wherein a stop order price is further based on a second price equal to a market price of the tradable instrument at the time of trade order activation.

26. The method of claim 24, wherein a stop order price is further based on a second price equal to the first price plus a predetermined offset amount.

27. The method of claim 26, wherein the second price is equal to the first price minus the predetermined offset when the stop order is a sell stop order.

28. The method of claim 26, wherein the second price is equal to the first price plus the predetermined offset when the stop order is a buy stop order.

29. The method of claim 26, wherein the predetermined offset amount comprises a fixed number of ticks upward from the first price when the stop order is a buy stop order and a fixed number of ticks downward from the first price when the stop order is a sell stop order.

30. The method of claim 24, wherein the plurality of preset parameters is selected from the group consisting of trade order quantities, trading account information, trade order validity information, trade order restrictions and the predetermined amount.

31. The method of claim 24, wherein the user input device comprises a computer mouse having a right button to enable a right click, a left button to enable a left click and a center scroll wheel to enable scrolling.

32. The method of claim 24, wherein detecting the first user action comprises:
detecting a position of a pointer of the user input device over the trade order dartboard; and
detecting movement of the center scroll wheel, the movement causing the first price to be displayed in the selected-price display.

33. The method of claim 24, wherein detecting the first user action comprises detecting movement of the center scroll wheel, the movement causing the first price to be displayed in the selected-price display.

34. The method of claim 24, wherein detecting the first user action comprises detecting a position of a pointer of the user input device over the trade order dartboard.

35. The method of claim 24, wherein detecting the second user action comprises detecting a right click with the pointer of the user input device positioned over a price associated with the plurality of ask quantities.

36. The method of claim 24, wherein detecting the second user action comprises detecting a left click with the pointer of the user input device positioned over a price associated with the plurality of bid quantities.

37. The method of claim 24, wherein detecting the second user action comprises detecting a left click with the pointer of the user input device positioned over a bid quantity of the plurality of bid quantities.

38. The method of claim 24, wherein detecting the second user action comprises detecting a left click with the pointer of the user input device positioned over a ask quantity of the plurality of ask quantities.

39. The method of claim 24, wherein the first price is changed to another price of the plurality of prices in response to detecting movement of the center scroll wheel.

40. The method of claim 24, wherein the tradable instrument is selected from the group consisting of equities, options, futures, warrants, bonds, commodities and currencies.

41. The method of claim 24, wherein detecting selection of the first button image comprises detecting a first left click with the pointer of the user input device positioned over the first button image.

42. A computer readable medium having program code recorded thereon for execution on a computer to place a trade order for a tradable instrument on an electronic exchange, comprising:
a first program code for displaying a trade order dartboard, the trade order dartboard displaying a market depth of the tradable instrument comprising information representing orders at an inside market and orders outside of the inside market through a dynamic display of a plurality of prices and a plurality of bid quantities and ask quantities in the market for the tradable instrument;
a second program code for displaying a selected-price display on the trade order dartboard, the selected-price display displaying a first price of the plurality of prices in the selected-price display in response to detecting a first user action via a user input device;
a third program code for initiating placement of a trade order relating to the tradable instrument at the first price in response to detecting a second user action via the user input device; and
a fourth program code for setting a trade order price of the trade order based in part upon one of a plurality of preset parameters and the first price.

43. A computer readable medium having program code recorded thereon for execution on a computer according to claim 42, further comprising program code for establishing that the trade order is an order to sell a quantity of the tradable instrument at the trade order price.

44. A computer readable medium having program code recorded thereon for execution on a computer according to claim 42, further comprising program code for establishing that the trade order is an order to buy a quantity of the tradable instrument at the trade order price.

45. A computer readable medium having program code recorded thereon for execution on a computer according to claim 42, further comprising program code for detecting a right click, a left click and a center scroll wheel movement of the user input device.

46. A computer readable medium having program code recorded thereon for execution on a computer according to claim 45, further comprising program code for detecting the first user action when a position of a pointer of the user input device is detected over the trade order dartboard and when center scroll wheel movement is detected.

47. A computer readable medium having program code recorded thereon for execution on a computer according to claim 45, further comprising program code for detecting the first user action when center scroll wheel movement is detected.

48. A computer readable medium having program code recorded thereon for execution on a computer according to claim 45, further comprising program code for detecting the first user action when a position of a pointer of the user input device is detected over the trade order dartboard.

49. A computer readable medium having program code recorded thereon for execution on a computer according to claim 45, further comprising program code for detecting the second user action when a right click with the pointer of the user input device positioned over a price associated with the plurality of ask quantities is detected.

50. A computer readable medium having program code recorded thereon for execution on a computer according to claim 45, further comprising program code for detecting the second user action when a left click with the pointer of the user input device positioned over a price associated with the plurality of bid quantities is detected.

51. A computer readable medium having program code recorded thereon for execution on a computer according to claim 45, further comprising program code for detecting the second user action when a left click with the pointer of the user input device positioned over a bid quantity of the plurality of bid quantities is detected.

52. A computer readable medium having program code recorded thereon for execution on a computer according to claim 45, further comprising program code for detecting the second user action when a left click with the pointer of the user input device positioned over a ask quantity of the plurality of ask quantities is detected.

53. A computer readable medium having program code recorded thereon for execution on a computer according to claim 45, further comprising program code for changing the first price to another price of the plurality of prices in response to detecting center scroll wheel movement.

54. A computer readable medium having program code recorded thereon for execution on a computer according to claim 42, further comprising program code for adjusting a position of the selected-price display on the trade order dartboard.

55. A computer readable medium having program code recorded thereon for execution on a computer according to claim 42, further comprising program code for establishing that a position of the selected-price display is based on the first user action.

56. A computer readable medium having program code recorded thereon for execution on a computer according to claim 42, further comprising program code for establishing that the selected-price display is displayed in a bid quantity column of the trade order dartboard when the pointer of the user input device is positioned over an ask quantity of the plurality ask quantities.

57. A computer readable medium having program code recorded thereon for execution on a computer according to claim 42, further comprising program code for establishing that the selected-price display is displayed in a bid quantity column of the trade order dartboard when the pointer of the user input device is positioned over a limit price associated with the plurality ask quantities.

58. A computer readable medium having program code recorded thereon for execution on a computer according to claim 42, further comprising program code for establishing that the selected-price display is displayed in an ask quantity column of the trade order dartboard when the pointer of the user input device is positioned over a bid quantity of the plurality bid quantities.

59. A computer readable medium having program code recorded thereon for execution on a computer according to claim 42, further comprising program code for establishing that the selected-price display is displayed in an ask quantity column of the trade order dartboard when the pointer of the user input device is positioned over a limit price associated with the plurality bid quantities.

60. A client system for placing a trade order for a tradable instrument on an electronic exchange, the system comprising:
a display device configured to display a trade order dartboard and a selected-price display on the trade order dartboard, the trade order dartboard displaying a market depth of the tradable instrument comprising information representing orders at an inside market and orders outside of the inside market through a dynamic display of a plurality of prices and a plurality of bid quantities and ask quantities in the market for the tradable instrument;
a user input device configured to enable a first user action causing a first price of the plurality of prices to be displayed in the selected-price display, and configured to enable a second user action to initiate placement of a trade order relating to the tradable instrument at the first price; and
a trade order characteristic setting component configured to set a trade order price of the trade order based in part upon one of a plurality of preset parameters and the first price.

61. The client system of 60, wherein the trade order characteristic setting component establishes that the trade order is an order to sell a quantity of the tradable instrument at the trade order price.

62. The client system of 60, wherein the trade order characteristic setting component establishes that the trade order is an order to buy a quantity of the tradable instrument at the trade order price.

63. The client system of 60, wherein the trade order characteristic setting component detects a right click, a left click and a center scroll wheel movement of the user input device.

64. The client system of 63, wherein the trade order characteristic setting component detects the first user action when a position of a pointer of the user input device is detected over the trade order dartboard and when center scroll wheel movement is detected.

65. The client system of 63, wherein the trade order characteristic setting component detects the first user action when center scroll wheel movement is detected.

66. The client system of 63, wherein the trade order characteristic setting component detects the first user action when a position of a pointer of the user input device is detected over the trade order dartboard.

67. The client system of 63, wherein the trade order characteristic setting component detects the second user action when a right click with the pointer of the user input device positioned over a price associated with the plurality of ask quantities is detected.

68. The client system of 63, wherein the trade order characteristic setting component detects the second user action when a left click with the pointer of the user input device positioned over a price associated with the plurality of bid quantities is detected.

69. The client system of 63, wherein the trade order characteristic setting component detects the second user action when a left click with the pointer of the user input device positioned over a bid quantity of the plurality of bid quantities is detected.

70. The client system of 63, wherein the trade order characteristic setting component detects the second user action when a left click with the pointer of the user input device positioned over a ask quantity of the plurality of ask quantities is detected.

71. The client system of 63, wherein the trade order characteristic setting component changes the first price to another price of the plurality of prices in response to detecting center scroll wheel movement.

72. The client system of 60, wherein the trade order characteristic setting component adjusts a position of the selected-price display on the trade order dartboard.

73. The client system of 60, wherein the trade order characteristic setting component establishes that the position of the selected-price display is based on the first user action.

74. The client system of 60, wherein the trade order characteristic setting component establishes that the selected-price display is displayed in a bid quantity column of the trade order dartboard when the pointer of the user input device is over an ask quantity of the plurality ask quantities.

75. The client system of 60, wherein the trade order characteristic setting component establishes that the selected-price display is displayed in a bid quantity column of the trade order dartboard when the pointer of the user input device is over a limit price associated with the plurality ask quantities.

76. The client system of 60, wherein the trade order characteristic setting component establishes that the selected-price display is displayed in an ask quantity column of the trade order dartboard when the pointer of the user input device is over a bid quantity of the plurality bid quantities.

77. The client system of 60, wherein the trade order characteristic setting component establishes that the selected-price display is displayed in an ask quantity column of the trade order dartboard when the pointer of the user input device is over a limit price associated with the plurality bid quantities.
